(19) United States
(12) Patent Application Publication
(10) Pub. No.: US 2025/0285462 A1
(43) Pub. Date: Sep. 11, 2025

(54) METHOD AND SYSTEM FOR PROCESSING OF DOCUMENTS ASSOCIATED WITH A CANDIDATE PETITION, INITIATIVE, REFERENDUM, OR OTHER BALLOT MEASURE PETITION, AND OTHER VOTER ACTION

(71) Applicant: Veracity Petitions, LLC, Phoenix, AZ (US)

(72) Inventors: Michael Scott Reed, Del Mar, CA (US); Eric H. Spencer, Phoenix, AZ (US); Kris Passow, Mesa, AZ (US)

(73) Assignee: Veracity Petitions, LLC, Phoenix, AZ (US)

(21) Appl. No.: 19/072,803

(22) Filed: Mar. 6, 2025

Related U.S. Application Data
(60) Provisional application No. 63/562,361, filed on Mar. 7, 2024.

(51) Int. Cl. G06V 30/41; G06F 40/169; G06F 40/177; G06V 30/146; G06V 30/19; G06V 30/42; G07C 13/00

(52) U.S. Cl. CPC G06V 30/41; G06F 40/169; G06F 40/177; G06V 30/147; G06V 30/19147; G06V 30/42; G07C 13/00; G06Q 2230/00

(57) ABSTRACT

A method for processing scanned images of a document related to one or more voter related actions. The method can include identifying, by analyzing a plurality of scanned images of documents associated with a voter related action, a document type and a plurality of areas of interest of at least one of the scanned images; determining a value of each of the plurality of areas of interest; and identifying one or more bases of challenging a document of the at least one of the scanned images of the voter related action by considering whether a relationship between at least one record of voter registration data of a voter registration database and the value of one or more of the plurality of areas of interest satisfies one or more predetermined rules for acceptance according to the voter related action.

### CROSS-REFERENCE TO RELATED APPLICATIONS

This application claims priority to and the benefit of U.S. provisional patent application No. 63/562,361 filed Mar. 7, 2024, the contents of which are incorporated herein by reference in their entirety as if set forth verbatim for all purposes.

### FIELD

This disclosure generally relates to computer-implemented methods and systems related to processing documents associated with voter-related activities (e.g., candidate petitions, initiative, petition measures, referendum petition measures, and other forms of ballot petition measures, etc.), including processing and analytics thereof.

### BACKGROUND

The demand for systems capable of processing batches of voter related documents has increased substantially in recent years. However, current systems are generally limited, including their absence of efficient registered voter verification, flexibility and litigation support. This disclosure resolves these and other issues of the prior art systems.

### SUMMARY

In various embodiments, a computer-implemented system is disclosed that includes memory storing instructions and a processor configured to execute the instructions to perform operations. The system may be configured to identify, by analyzing a plurality of scanned images of a voter related action, a document type and a plurality of areas of interest of at least one of the scanned images; determine a value of each of the plurality of areas of interest; and identify one or more bases of challenging a document of at least one of the scanned images of the voter related action, considering whether a relationship between at least one record of voter registration data of a voter registration database and the value of one or more of the plurality of areas of interest satisfies one or more predetermined rules for acceptance according to the voter related action.

In various embodiments, the document includes or is related to a candidate petition, an initiative measure petition, a referendum measure petition, and/or the like.

In various embodiments, the determining the value of each of the plurality of areas of interest includes determining, using a cloud-based computer vision machine learning system that applies optical character recognition to the each of the plurality of areas of interest to identify characters of the value.

In various embodiments, the system is further configured to verify the one or more bases of challenging the document in a display dashboard; and generate, based on the verifying the one or more bases, a petition challenge score including available grounds to challenge the document.

In various embodiments, the system is further configured to generate an annotated image by automatically annotating at least one of the areas of interest with overlayed analytics related to at least one identified basis of challenging the document; and present the annotated image in a user interface.

In various embodiments, the system is further configured to generate an annotated image by automatically annotating at least one of the areas of interest with overlayed analytics related to at least one identified basis of challenging the document; and automatically modify the annotated image in a predetermined filing format with one or more litigation tags.

In various embodiments, the system includes a data pipeline in communication with a machine learning model comprising cognitive services trained on historical voter and/or petition data, a database comprising transcription data, and a cloud based storage. The system can be further configured to execute, using at least the data pipeline, a scanned image data query and a signature data query of the plurality of scanned images; and load, using at least the data pipeline and the signature data grouping query, output of the executed scanned image data query and the signature data query into one or more tables prior to the operation to identify the one or more bases of challenging the document.

In various embodiments, the system is further configured to automatically generate a table including data of each basis of challenging the document, the table being formed in a predetermined filing format according to one or more litigation rules.

In various embodiments, a method for processing scanned images of a document related to voter related actions may include identifying, by analyzing a plurality of scanned images of documents associated with the voter related action, a document type and a plurality of areas of interest of at least one of the scanned images; determining a value of each of the plurality of areas of interest; and identifying one or more bases of challenging a document of the at least one of the scanned images of the voter related action by analyzing a relationship between at least one record of voter registration data of a voter registration database and the value of one or more of the plurality of areas of interest and predetermined rules for acceptance according to the voter related action.

In various embodiments, the document includes a petition. In various embodiments, the determining the value of each of the plurality of areas of interest includes determining, using a cloud-based computer vision machine learning system that applies optical character recognition to the each of the plurality of areas of interest to identify characters of the value. In various embodiments, the method includes training the cloud-based computer vision machine learning system by receiving one or more training images of documents associated with the voter related action; receiving a plurality of data on a level of the areas of interest, values, and rules for acceptance according to the voter related action.

In various embodiments, the method can include loading, using at least a data pipeline in connection with a cognitive service, a database comprising transcription data, and a cloud based storage, a scanned image data query, and a signature data grouping query, an output of each query into one or more tables prior to or concurrent with determining the value of each of the plurality of areas of interest according to one or more litigation rules.

In various embodiments, the method includes verifying the one or more bases of challenging the document in a display dashboard; and generating, based on the verifying the one or more bases, a petition challenge score including available grounds to challenge the document. In various embodiments, the method includes generating an annotated image by automatically annotating at least one of the areas of interest with overlayed analytics related to at least one identified basis of challenging the document; and presenting the annotated image in a user interface. In various embodiments, the method includes generating an annotated image by automatically annotating at least one of the areas of interest with overlayed analytics related to at least one identified basis of challenging the document; and automatically modifying the annotated image in a predetermined filing format with one or more litigation tags. In various embodiments, the method includes automatically generating a table including data of each basis of challenging the document, the table being formed in a predetermined filing format according to one or more litigation rules. In various embodiments, a method is disclosed for processing scanned images of a document related to a voter related action, including introducing scanned petition image data into a cloud-based image analyzer; comparing data packets associated with the scanned petition image data received from the cloud-based image analyzer with voter registration data to generate values associated with identified areas of interest of the document; and generating, based on the generated values, a score related to eligible bases to challenge the document related to the voter related action.

In various embodiments, the method includes generating an annotated image by automatically annotating at least one of the identified areas of interest with overlayed analytics related to at least one identified eligible basis of challenging the document; and presenting the annotated image in a user interface.

In various embodiments, the method includes executing, using at least a data pipeline, a scanned image data query and a signature data query of the scanned petition image data; and loading, using at least the data pipeline and the signature data grouping query, output of the executed scanned image data query and the signature data query into one or more tables.

To the accomplishment of the foregoing and related ends, certain illustrative aspects are described herein in connection with the following description and the appended drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

The above and further aspects of this invention are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIG. 1A is a diagram illustrating a simplified block architecture in accordance with various embodiments.

FIG. 1B is a diagram illustrating a simplified block architecture in accordance with various embodiments.

FIG. 2 is a diagram illustrating a simplified block architecture in accordance with various embodiments.

FIG. 3 is a diagram illustrating a simplified block architecture in accordance with various embodiments.

FIG. 4 is a diagram illustrating a simplified block architecture in accordance with various embodiments.

FIG. 5 is an example diagram illustrating a simplified block architecture in accordance with various embodiments.

FIG. 6 is an example screenshot depicting aspects of a user interface in accordance with various embodiments.

FIG. 7 is an example screenshot depicting aspects of a user interface in accordance with various embodiments.

FIG. 8 is an example screenshot depicting aspects of a user interface in accordance with various embodiments.

FIG. 9 is an example screenshot depicting aspects of a user interface in accordance with various embodiments.

FIG. 10 is an example screenshot depicting aspects of a user interface in accordance with various embodiments.

FIG. 11 is an example screenshot depicting aspects of a user interface in accordance with various embodiments.

FIG. 12 is an example screenshot depicting aspects of a user interface in accordance with various embodiments.

FIG. 13A is an example screenshot depicting aspects of a user interface in accordance with various embodiments.

FIG. 13B is an example screenshot depicting aspects of a user interface in accordance with various embodiments.

FIG. 14 is an example screenshot depicting aspects of a user interface in accordance with various embodiments.

FIG. 15 is a simplified block diagram illustrating example architecture in accordance with various embodiments.

FIG. 16 is a simplified block diagram illustrating example architecture in accordance with various embodiments.

FIG. 17 is a simplified block diagram illustrating example architecture in accordance with various embodiments.

FIG. 18 is a simplified block diagram illustrating example architecture in accordance with various embodiments.

FIG. 19 is a simplified block diagram illustrating example architecture in accordance with various embodiments.

FIG. 20 is a simplified block diagram illustrating example architecture in accordance with various embodiments.

FIG. 21 is an example screenshot depicting aspects of a user interface in accordance with various embodiments.

FIG. 22 is an example screenshot depicting aspects of a user interface in accordance with various embodiments.

FIG. 23 is an example screenshot depicting aspects of a user interface in accordance with various embodiments.

FIG. 24 is an example screenshot depicting aspects of a user interface in accordance with various embodiments.

FIG. 25 is an example screenshot depicting aspects of a user interface in accordance with various embodiments.

FIG. 26 is an example screenshot depicting aspects of a user interface in accordance with various embodiments.

FIG. 27 is an example screenshot depicting aspects of a user interface in accordance with various embodiments.

FIG. 28 is an example screenshot depicting aspects of a user interface in accordance with various embodiments.

FIG. 29 is an example screenshot depicting aspects of a user interface in accordance with various embodiments.

FIG. 30 is an example screenshot depicting aspects of a user interface in accordance with various embodiments.

FIG. 31 is a computer architecture diagram showing a general computing system for implementing aspects of the present disclosure in accordance with one or more embodiments described herein.

FIG. 32 is a flow diagram for operating the system of this disclosure, according to various embodiments.

FIG. 33 is a flow diagram for operating the system of this disclosure, according to various embodiments.

### DETAILED DESCRIPTION

The present disclosure relates to a computing system configured for managing aspects of petition challenges, ballot challenges, and challenging or auditing other such voter related actions. In particular, the system can include image processing of a document (e.g., a petition) in order to determine whether the document content thereof is valid or invalid according to requirements of a jurisdiction. In some embodiments, the computer-implemented system can include a web-based application configured to identify and track document challenge bases by leveraging data accessed from voter registration database(s) and by leveraging system generated document analysis templates defining rules and functions for analyzing documents of a voter related action. In some aspects, scanned image data can be include character recognition associated with fields of interest of the document and any other information in question of the scanned image. The web-based app can permit end-users, including one or more administrators, works, and other users, to share tasks and monitor progress of document challenge operations.

As discussed herein, “a voter related action” may include, but is not limited to, a candidate petition, initiative ballot measure petition, a referendum ballot measure petition, recall ballot measure petition, or any other voter related action that can involve or otherwise require one or more voters in a given jurisdiction.

As discussed herein, “user” may include, but is not limited to, a worker, an employee, an administrator, a candidate, an election volunteer, any party or individual involved with challenging or otherwise involved in a voter related action.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form. Accordingly, “a module” or “the module” may refer to one or more modules where applicable.

Unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

It must also be noted that, as used in the specification and the appended claims, the singular forms “a,” “an” and “the” include plural referents unless the context clearly dictates otherwise. By “comprising” or “containing” or “including” it is meant that at least the named compound, element, particle, or method step is present in the composition or article or method, but does not exclude the presence of other compounds, materials, particles, method steps, even if the other such compounds, material, particles, method steps have the same function as what is named.

Relative terms, such as “about,” “substantially,” or “approximately” are used to include small variations with specific numerical values (e.g., +/−x %), as well as including the situation of no variation (+/−0%). In various embodiments, the numerical value x is less than or equal to 10—e.g., less than or equal to 5, to 2, to 1, or smaller.

The terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

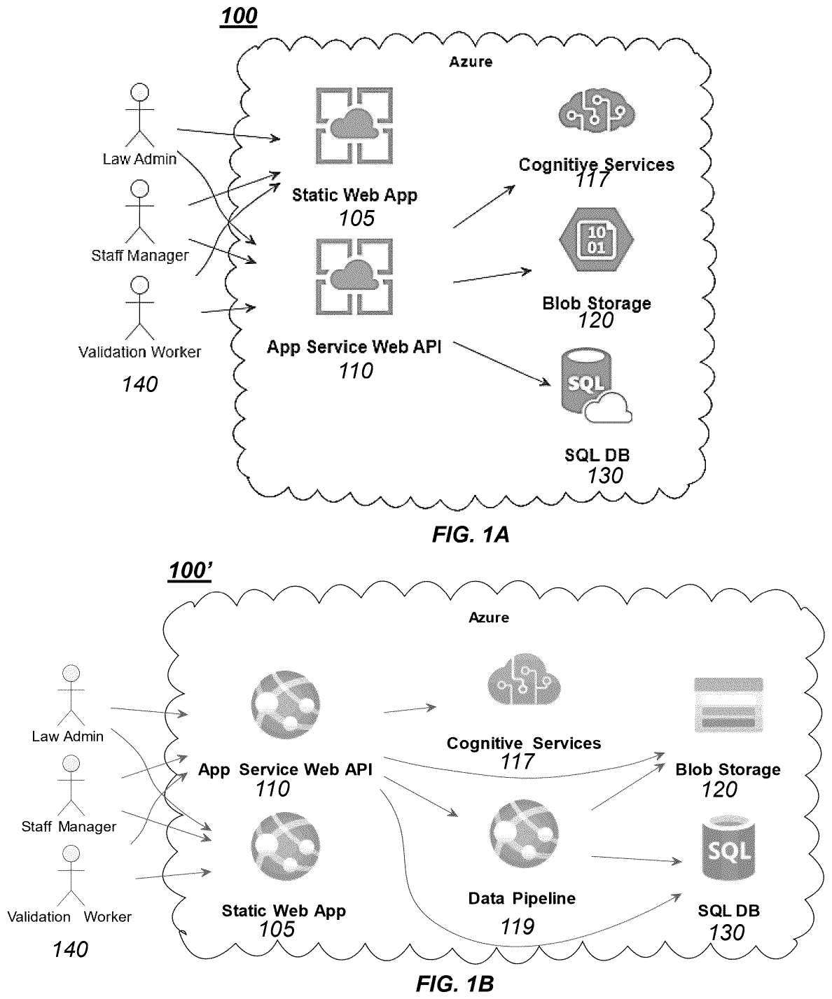

Referring to FIG. 1A, an exemplary system 100 of this disclosure is depicted, which can be or include a cloud-based platform (e.g., Azure cloud of Microsoft®) with associated administrative controls. Other cloud-based platforms contemplated for use with system 100 can include Amazon Web Services (AWS), Google Cloud Platform (GCP), Oracle Cloud Infrastructure (OCI), Cisco Cloud Solutions (CCS), Hewlett Packard Enterprise (HPE) GreenLake, IBM Cloud Platform, VMware Cloud, and DigitalOcean Droplets. System 100 can include a static web app 105 and an app service 110 with a web user interface (UI). App service 110 can include an API that drives the application of system 100. The static web app 105 and the app service 110 can be in communication with one or more aspects, such as cognitive services 117, blob storage 120 (which can be a cloud-based storage system that stores unstructured data in data chunks known as “blobs”, as described more particularly below), and SQL database 130 (e.g., a relational database or any database that stores and organizes data into structured tables of rows and columns). Cognitive services 117 can include one or more machine learning that can include operations such as knowledge management, data ingestion, and data population based out input voter and petition data that can be stored in one or more aspects of system 100. Cognitive services 117 can include software development tools that can be used by a petition data ingestion module. In some aspects, app service 110 is configured to upload scanned image data (e.g., png/pdf files) of scanned documents that can be stored (e.g., in blob storage 120).

A PDF may include text, images, multimedia elements, web page links, execute JavaScript and include other content. A PDF may include different layers comprising a header, body, xref table and trailer. The header may be in the first line of the PDF file and include a version number of the PDF file format specification used by the document. The body of the PDF document may include objects. The objects may include text, text streams, images, other multimedia elements, etc. The body section may hold all the document's data visible by the user. The xref table may include a cross-reference table. The cross-reference table may include the references to all the objects in the document. The cross-reference table allows random access to objects in the file, so the entire PDF document does not need to be reviewed in order to locate the particular object. Each object may be represented by one entry in the cross-reference table, which may be 20 bytes long. To access the cross-reference table, the system may open the PDF with a text editor. The cross-reference table may include four subsections including the object number, the number of objects in the subsection and the object represented by a number. The trailer provides information to the application reading the PDF document about how the application may find the cross-reference table and other special objects. The PDF may include incremental updates by appending objects to the end of the PDF file, without having to rewrite the entire file. Because of this process for updates, changes to a PDF document can be saved quickly.

In various embodiments, the system may include a method of determining if a document is a true PDF document. A true PDF document may include a digitally created PDF that may consist of text and/or images. The PDF may be created using software such as Microsoft® Word, Excel® or via the “print” function within a software application (virtual printer). To determine if the document is a true PDF, in various embodiments, the system may analyze the metadata of the PDF file. The metadata may be stored as part of the PDF file properties. The system may read the metadata by extracting the file properties of a given PDF file, wherein the PDF file properties may include, for example, the number of pages, dimensions of pages, details of images, text elements, etc. The system may also review a metadata field called hidden-text. If the value of this hidden-text field is set to false, the system marks the page as a true pdf page.

The system 100, including but not limited to cognitive services 117, can identify signatures (e.g., signature data) from scanned imaged data (e.g., batches of uploaded sheets), including information about one or more deficiencies in petitions as well as signatures. In some aspects, the scanned image data can be introduced into system 100 and evaluated by cognitive services 117 by one or more users 140 (e.g., law administrator, staff manager at a polling station, a voter validation worker, etc.). In some aspects, system 100 can identify (e.g., by cognitive services analyzing scanned images of documents (e.g., petitions) associated with a voter related action), a document type and a plurality of areas of interest of at least one of the scanned images. A value of each of the plurality of areas of interest can be determined and one or more bases of challenging a document of the at least one of the scanned images can be identified. In some aspects, the one or more bases can be identified at least by analyzing a relationship between at least one record of voter registration data of a voter registration database and the value of one or more of the plurality of areas of interest and predetermined rules for acceptance according to the voter related action. The system 100 can also identify the system user or external system that performed prior operations, such as transcription work and how quickly that can be stored in SQL database 130.

Referring to FIG. 1B, an exemplary system 100′, similar to system 100, is shown. In the depicted example, system 100′ can include data pipeline 119 in addition to cognitive services 117, blob storage 120, and SQL database 130. Data pipeline 119 can execute a scanned image data query and signature data query (e.g., a signature data grouping query) of scanned images and load scanned image data into tables (e.g., signature, petition, and/or voter registration tables).

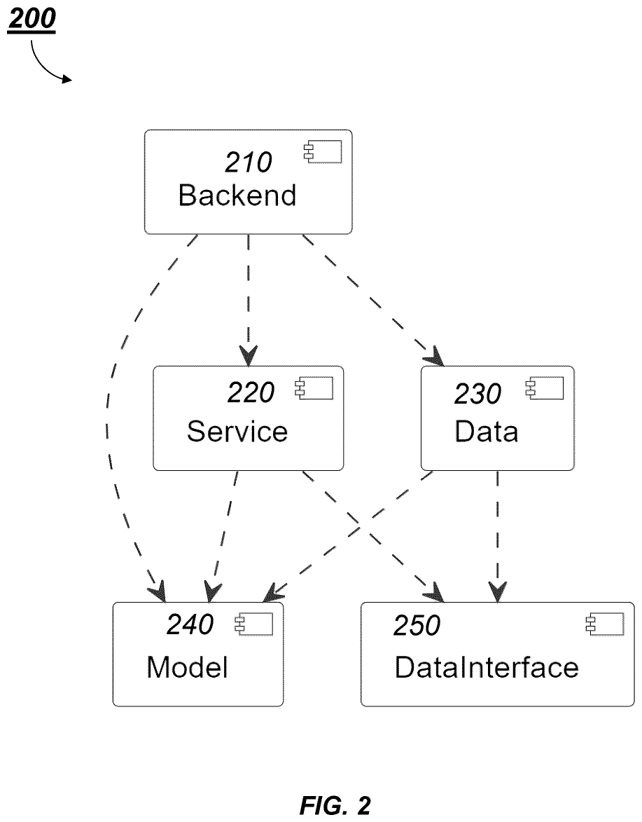

Referring to FIG. 2, exemplary system architecture 200 of this disclosure is depicted (e.g., architecture for system 100, system 100′, etc.), which can include backend architecture 210 in communication with a service module 220, a data module 230, a model 240, and a data interface 250.

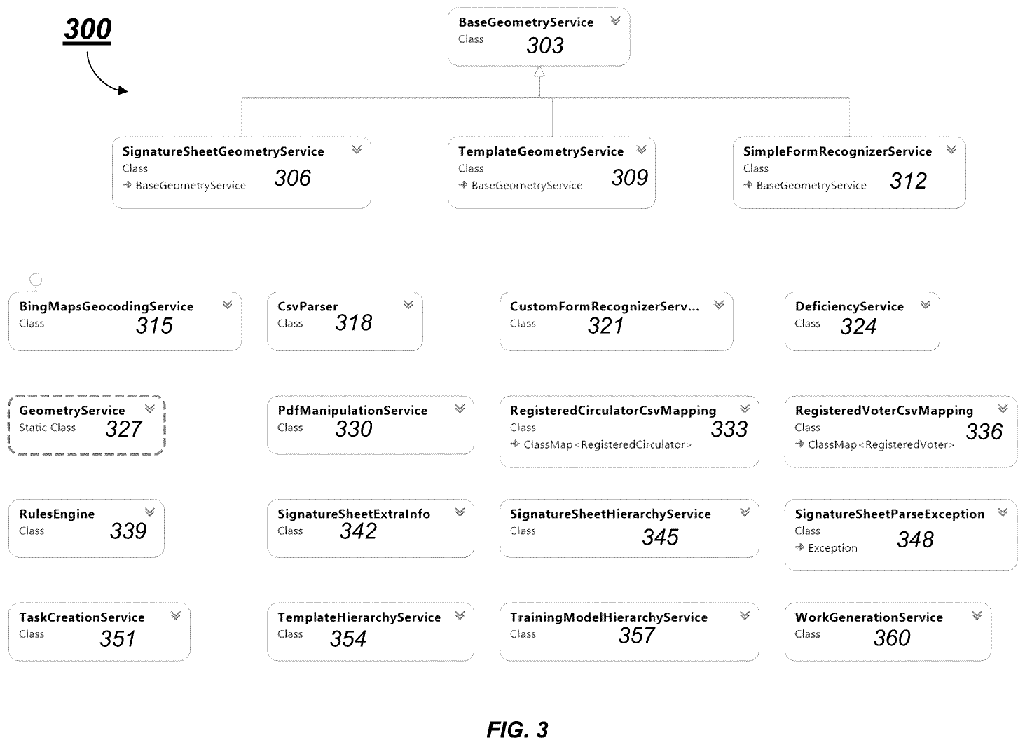

Referring to FIG. 3, exemplary service class architecture 300 of this disclosure is depicted, which can include a base geometry service module 303 in communication with signature sheet geometry service 306, template geometry service 309, and a simple form recognizer service module 312. Other contemplated non-limiting examples of service modules are illustrated (e.g., bing map geocoding service module 315, CSV parser module 318, custom form recognizer service module 321, deficiency service module 324, geometry service module 327, PDF manipulation service module 330, registered circulator CSV mapping module 333, registered voter CSV mapping module 336, rules engine 339, signature sheet extra info module 342, signature sheet hierarch service module 345, signature sheet parse exception module 348, task creation service module 351, template hierarchy service module 354, training model hierarchy service module 357, work generation service module 360, etc.).

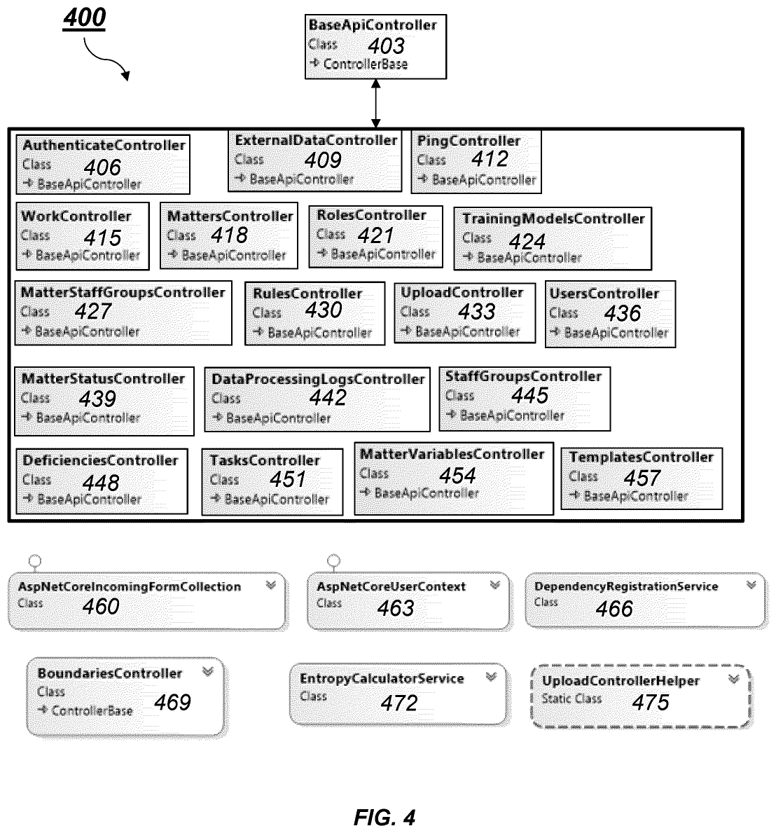

Referring to FIG. 4, exemplary backend class architecture 400 of this disclosure is depicted (e.g., architecture for system 100, system 100′, etc.), which can include a base API controller 403 (e.g., for use with service 110) in communication with sub-controllers, modules, and the like (e.g., including but not limited to authenticate controller 406, external data controller 409, ping controller 412, work controller 415, master controller 418, roles controller 421, training models controller 424, matter staff groups controller 427, rules controller 430, upload controller 433, users controller 436, matter status controller 439, data processing logs controller 442, staff groups controller 445, deficiencies controller 448, tasks controller 451, matter variables controller 454, templates controller 457, asp net core incoming form collection module 460, asp net core user context 463, dependency registration service module 466, boundaries controller 469, entropy calculator service 472, upload controller helper 475). Other contemplated non-limiting examples of sub-controllers and modules are illustrated.

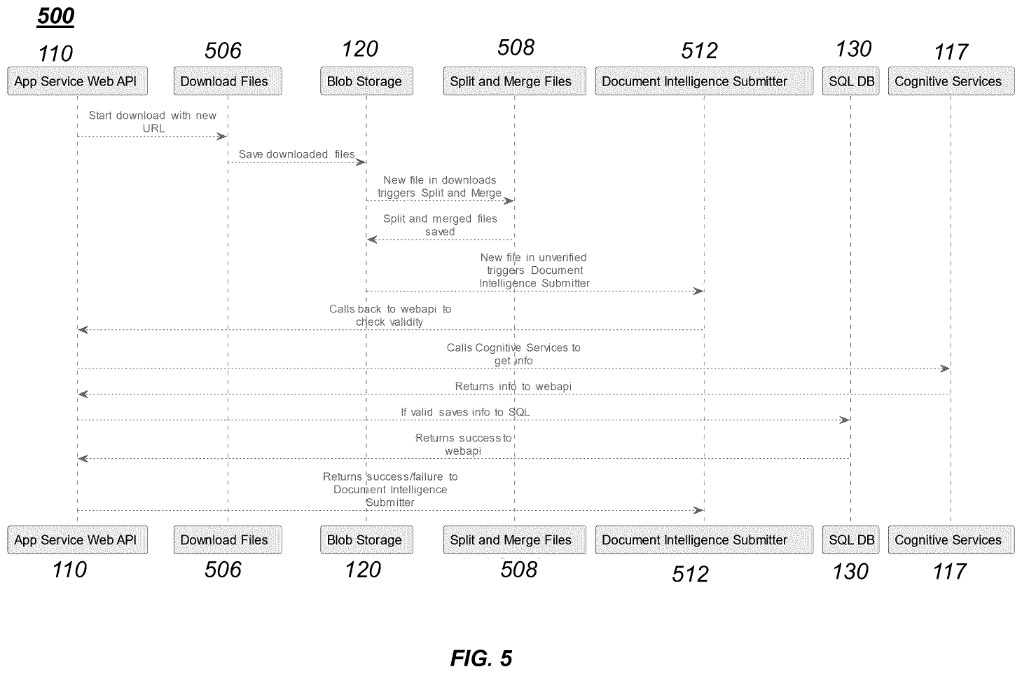

FIG. 5 is an example diagram illustrating a simplified block architecture 500 for operations related to system 100′ in accordance with various embodiments. In some aspects for operations related to data pipeline 119, app service 110 can begin perform download file operations 506, whereby a download can start with a new URL and files can be saved (e.g., saved to blob storage 120). Blob storage 120 can trigger split and merge file operations 508 so that files saved can be split and merged. Any new files that are unverified can cause document intelligence submitter 512 to communicate with app service 110 to perform validity check operations. App service 110 in turn can communicate with cognitive services 117 to obtain information related to the unverified new files and transmit that information to app service 110. In response to determining that the new filed is deemed valid, the information can be saved in SQL database 130. A return success notification and/or failure notification can be transmitted from SQL database 130 to document intelligence submitter 512.

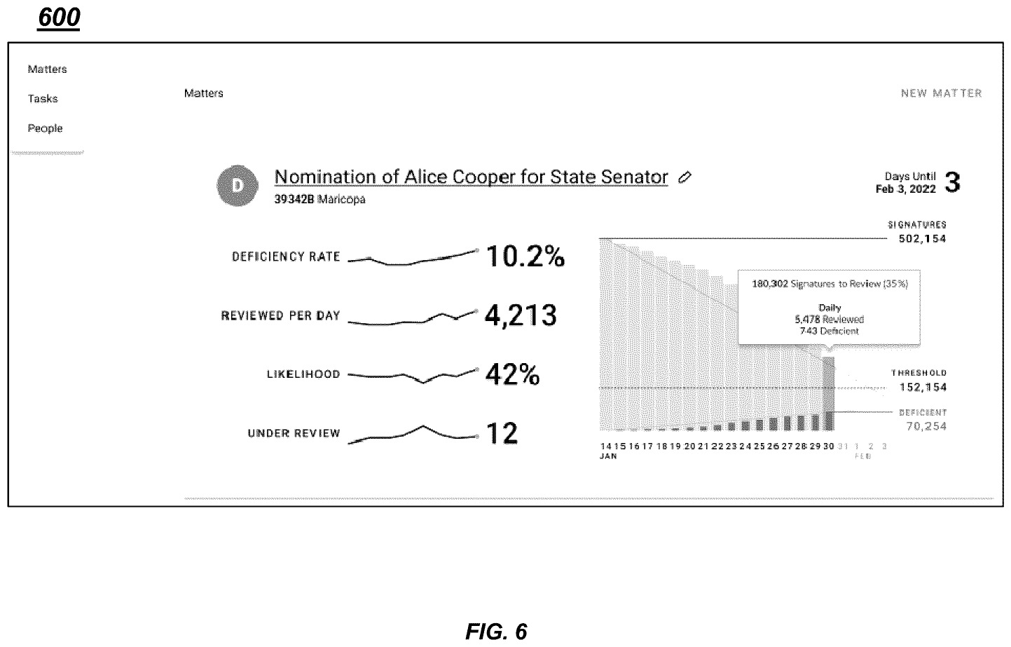

In one example operation, a user (e.g., an administrator) logs in, a user interface 600 (e.g., a dashboard) as in FIG. 6 can be presented. The interface of FIG. 6 can allow a user (e.g., user 140) to create a new matter related to petition analysis.

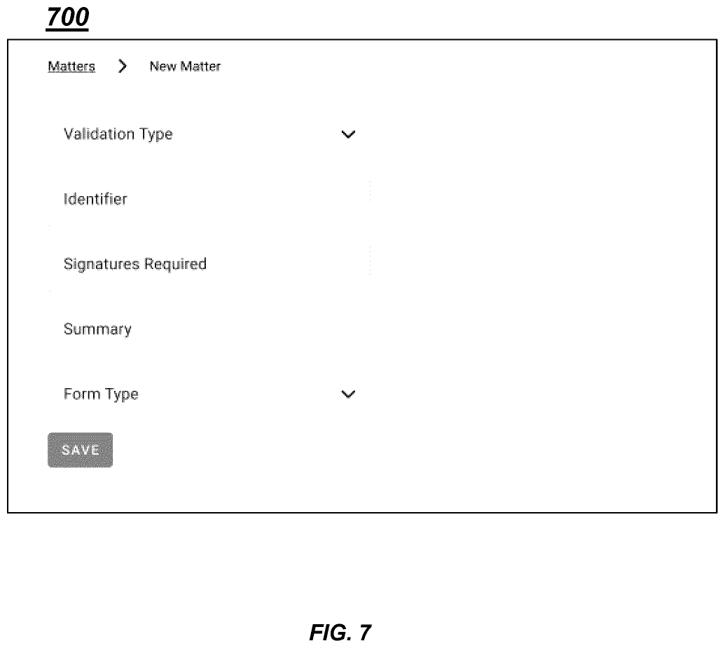

In one example operation, as in the interface 700 of FIG. 7, when creating a new matter, the user can enter in metadata about the matters and upload a related form (e.g., the official signature form) and optionally a voter registration file or other external database export. The user can also multi-upload one or more signature sheets.

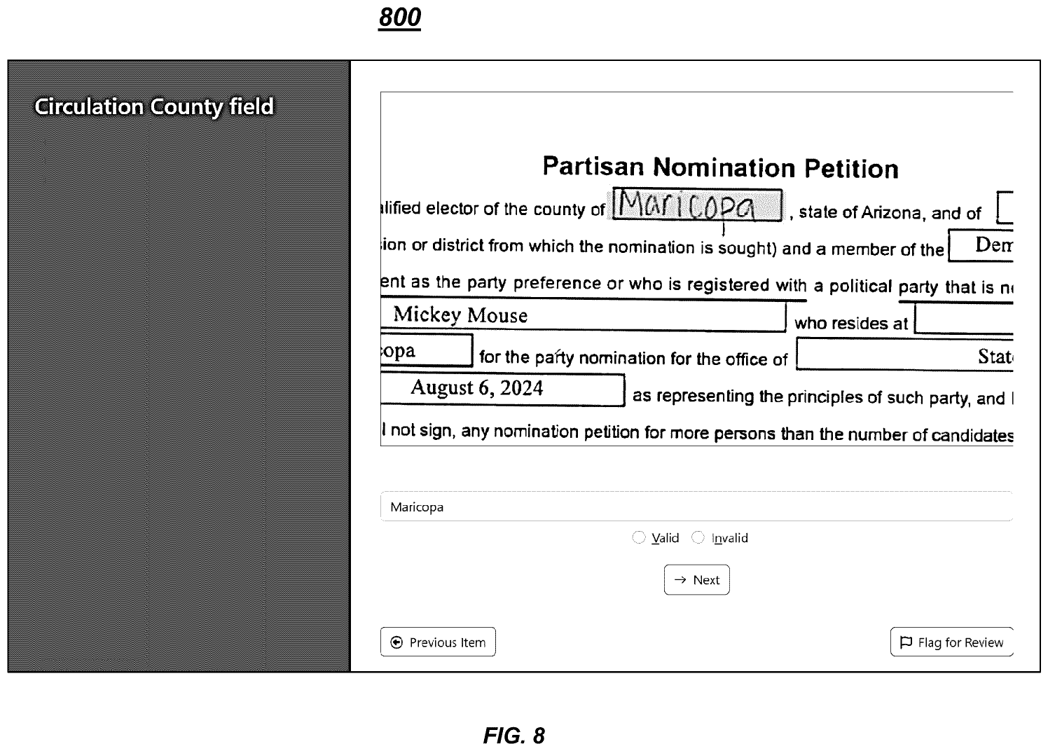

Turning to the example interface 800 of FIG. 8, in response to uploading the official form, the user can identify which fields requiring transcribing so they can be further analyzed by the system (e.g., system 100, 100′, etc.). In the interface 800 shown in FIG. 8, scanned image data has been analyzed, compared with voter registration data, and automatically annotated by the system with overlayed analytics related to each identified base of petition challenge.

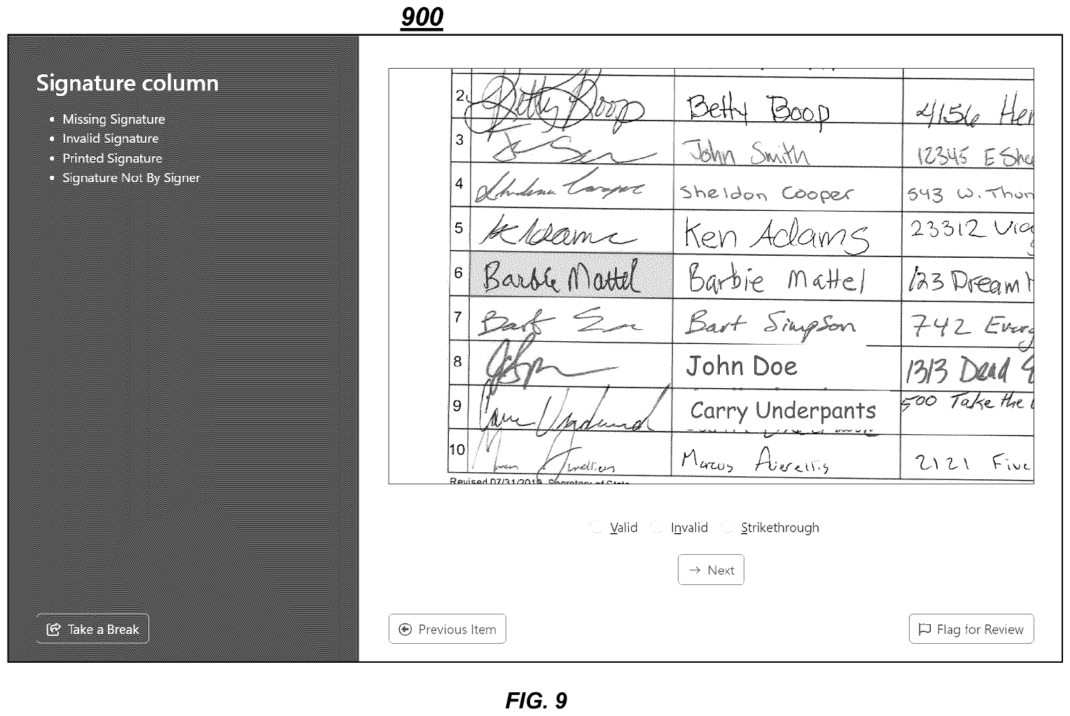

Turning to the example interface 900 of FIG. 9, the user can identify and/or name the columns used to analyzed scanned image data related to documents of a voter related action (e.g., candidate petitions, initiative, petition measures, referendum petition measures, and other forms of ballot petition measures, etc).

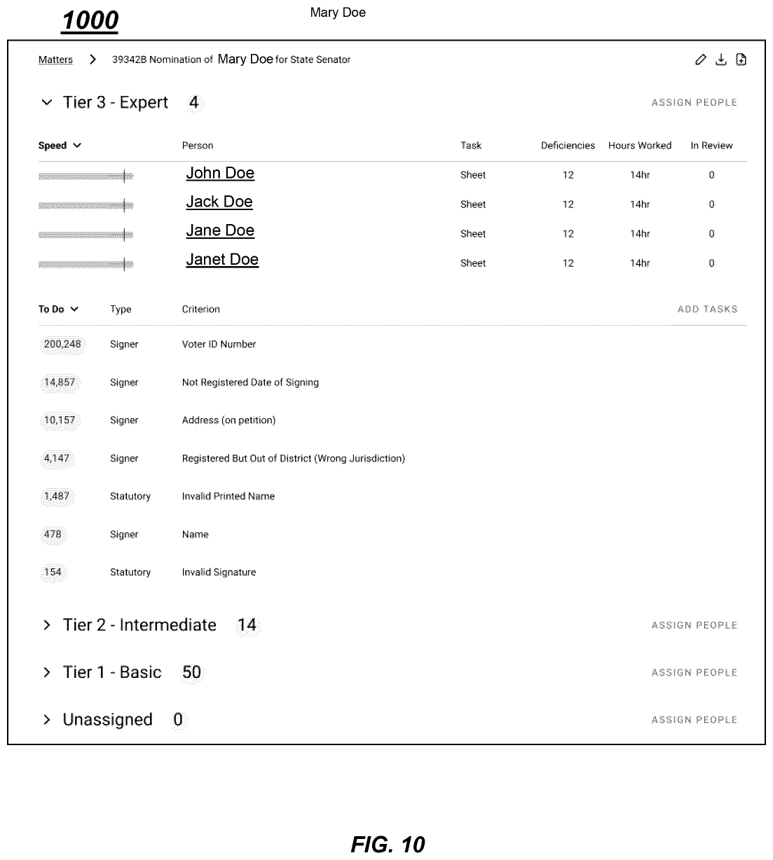

Turning to the example interface 1000 of FIG. 10, here the user (e.g., a staff manager user 140) can log in and see a dashboard interface that shows the current progress of analysis of scanned petition image data as well as a breakdown of worker performance.

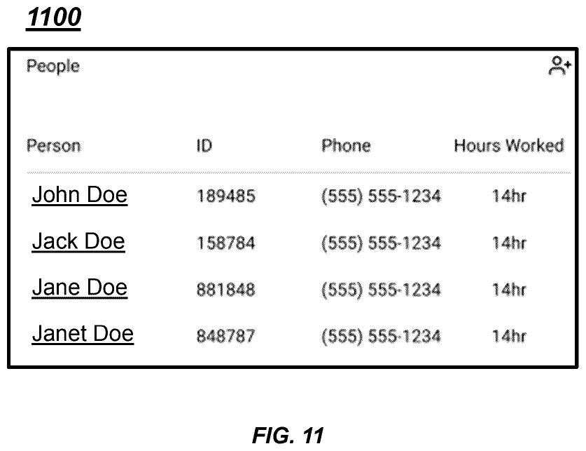

Turning to the example interface 1100 of FIG. 11, here the user can import other users facilitating the batch analysis of scanned imaged data related to scanned petitions. The user can observe workers from a spreadsheet or one at a time.

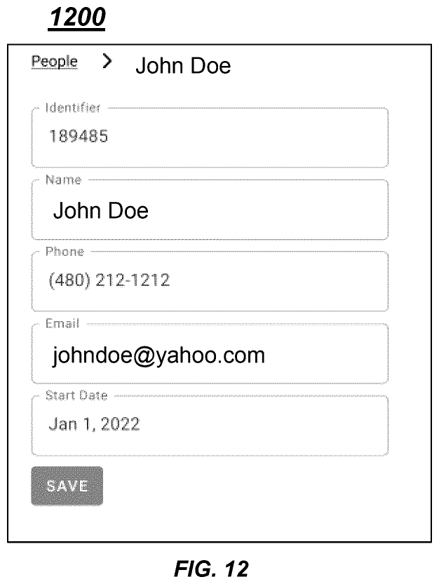

Turning to the example interface 1200 of FIG. 12, in response to saving, the user can receive a message (e.g., an invitation email) with automatically generated link to create user profile information (e.g., user and password).

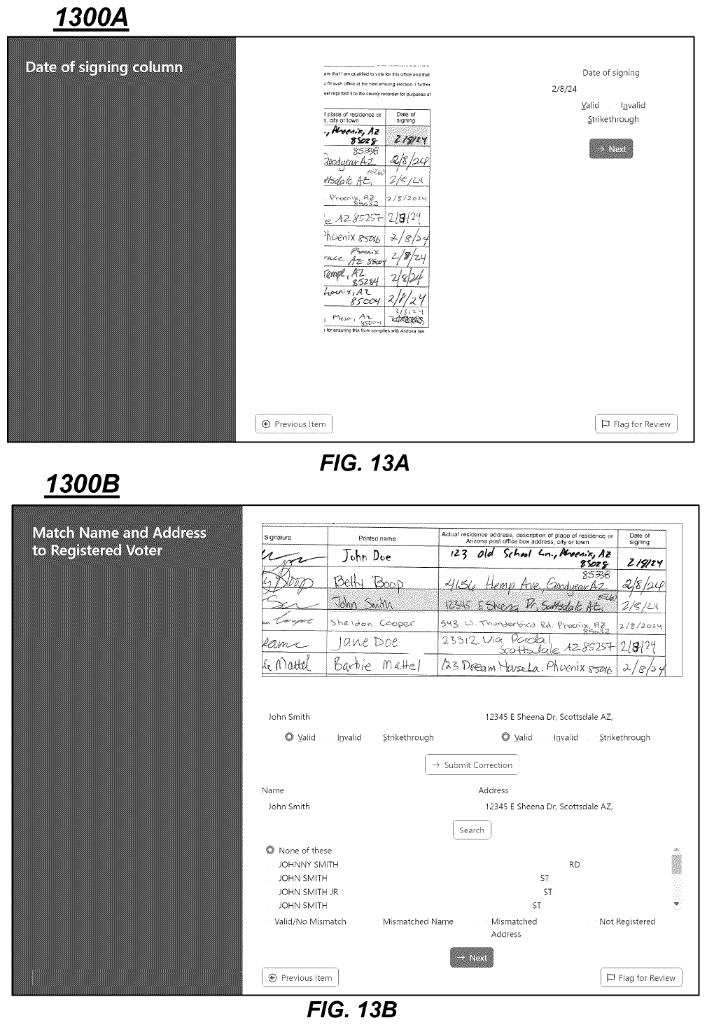

Turning to the example interface of FIG. 13A, when a user (e.g., a worker) logs into the system, the user can see a “begin task” interface 1300A such as the example of FIG. 13A. The user can also be presented with more complicated task, such as the interface 1300B shown in FIG. 13B.

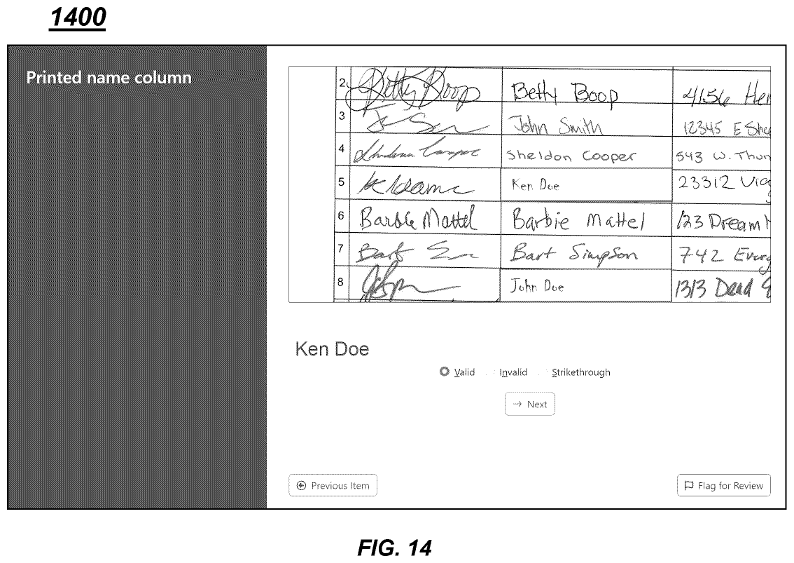

Turning to the example interface 1400 of FIG. 14, the user can also be presented with modified scanned image data of one or more areas of interest. The presented area of interest, previously analyzed by an optical character recognition module, can include identified characters to determine whether data related therewith presents a match with corresponding data of the voter registration database. The user can then facilitate transcription verification of the characters of the presented area of interest.

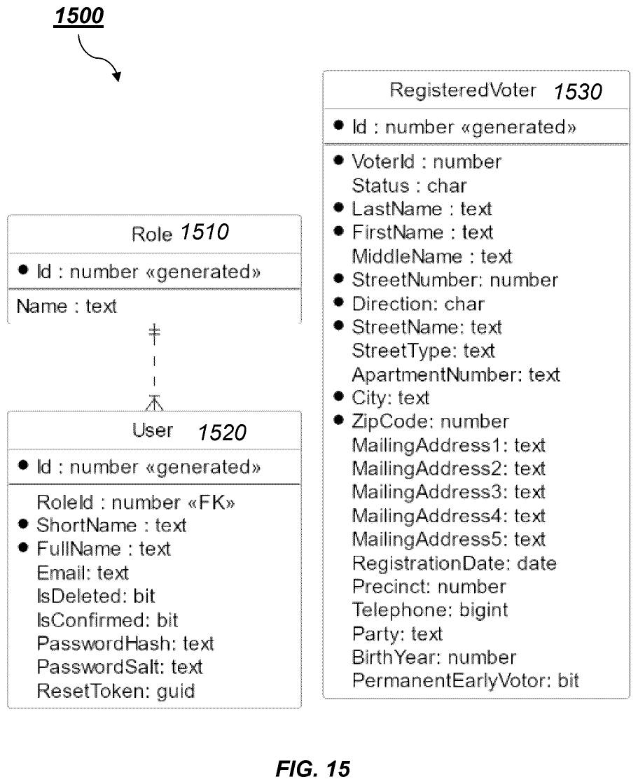

FIG. 15 is a simplified block diagram illustrating example architecture 1500 in accordance with various embodiments. In FIG. 15, the example architecture 1500 can include a role module 1510, a user module 1520, and a registered voter module 1530 for generating tables during system operations. In some aspects, each table used in operations of the system (e.g., systems 100, 100′, etc.) can exist in a single database and the tables generated during system operations can relate to users and registered voters.

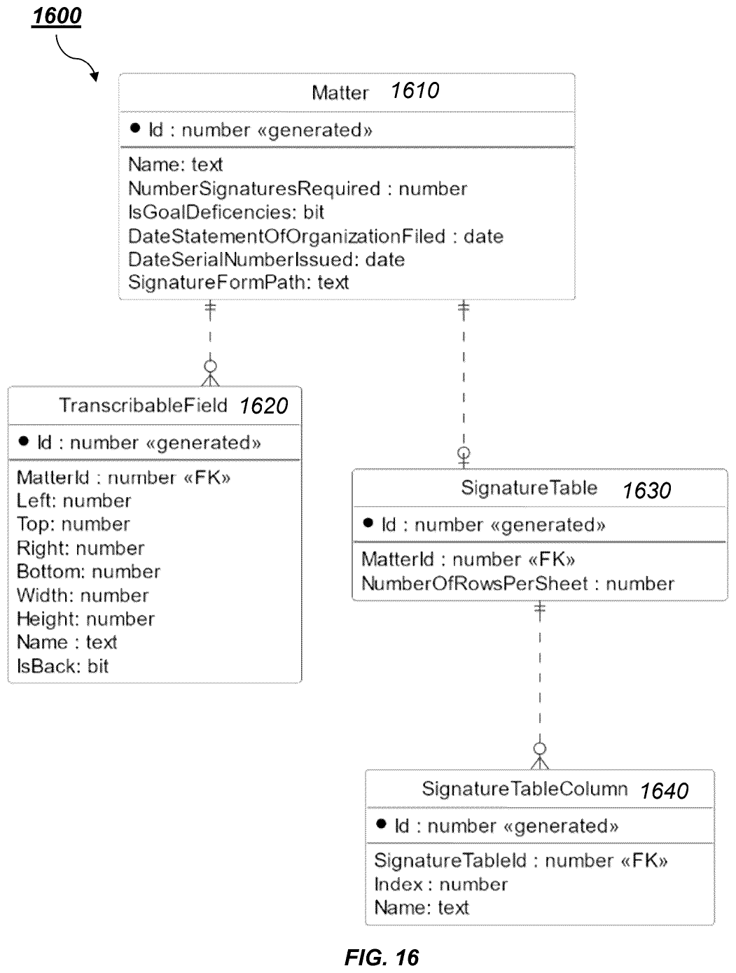

FIG. 16 is a simplified block diagram illustrating example architecture 1600 in accordance with various embodiments. In some aspects, the diagram of FIG. 16 relates to structure for tables associated with matter creation and the upload of a blank form operation, including table matter module 1610, transcribable field module 1620, signature table module 1630, and signature table column module 1640.

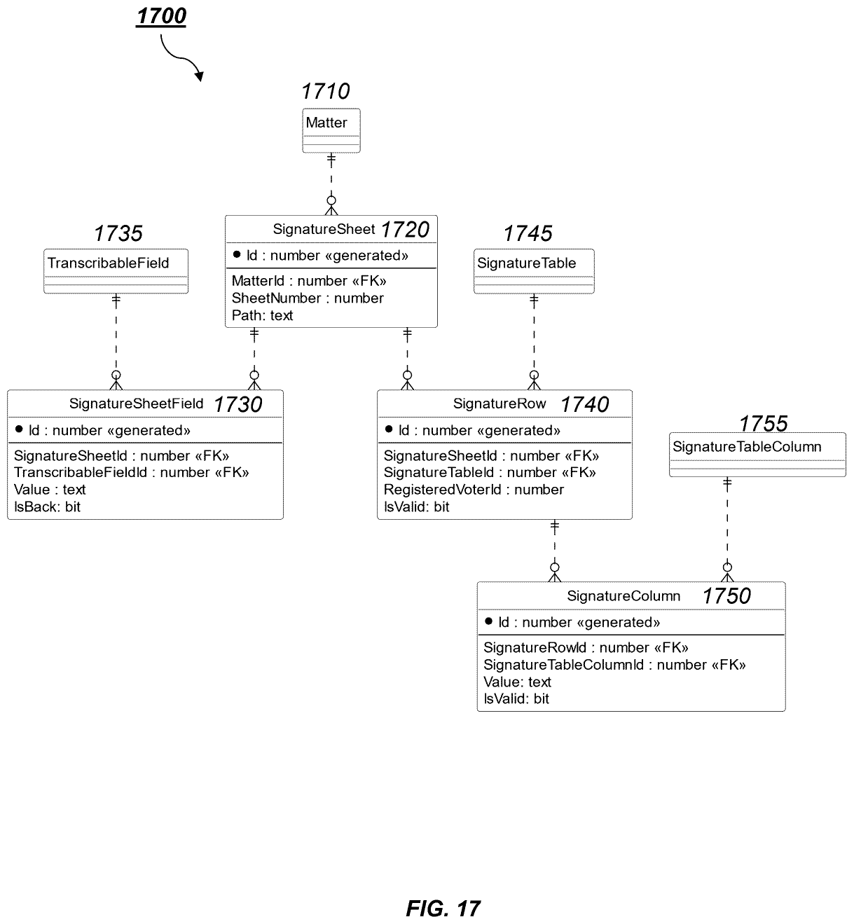

FIG. 17 is a simplified block diagram illustrating example architecture 1700 in accordance with various embodiments. In some aspects, the diagram of FIG. 17 relates to structure for tables associated with signature sheet multi-upload operations, including an initial matter operation 1710, signature sheet module 1720 that is in communication with signature sheet field module 1740, signature row module 1740, and signature column module 1750. Module 1730 can receive signature sheet data from module 1720 and analyze and/or determine actions related to transcribable field portion 1735. Module 1740 can receive signature sheet data from module 1720 and analyze and/or determine actions related to signature table portion 1745. Module 1750 can receive signature row data information from module 1740 and analyze and/or determine actions related to signature table column 1755.

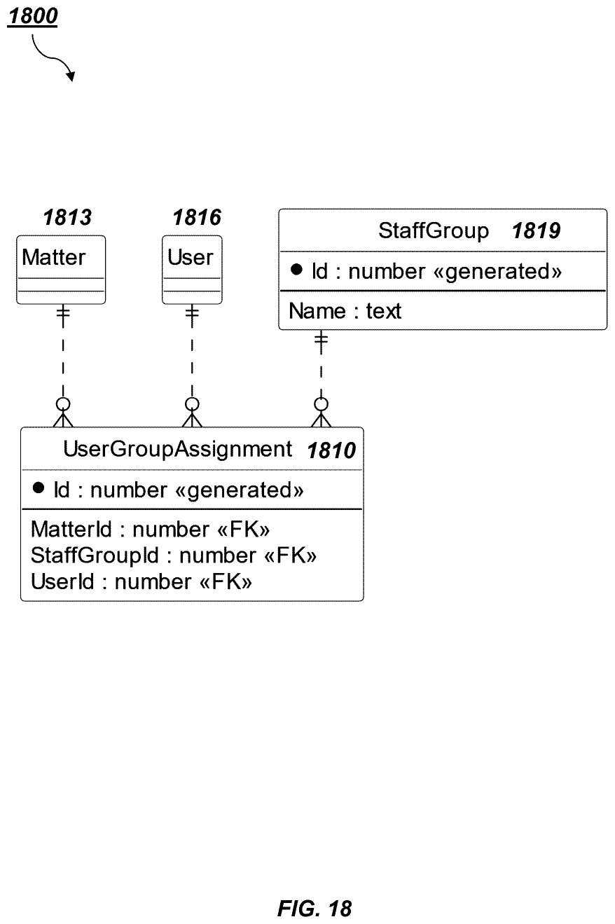

FIG. 18 is a simplified block diagram illustrating example architecture 1800 in accordance with various embodiments. In some aspects, the diagram of FIG. 18 relates to tables associated with staff manager user group assignment operations and group task assignment operations, including matter 1813, user 1816, and staff group 1819 with respect to user group assignment module 1810.

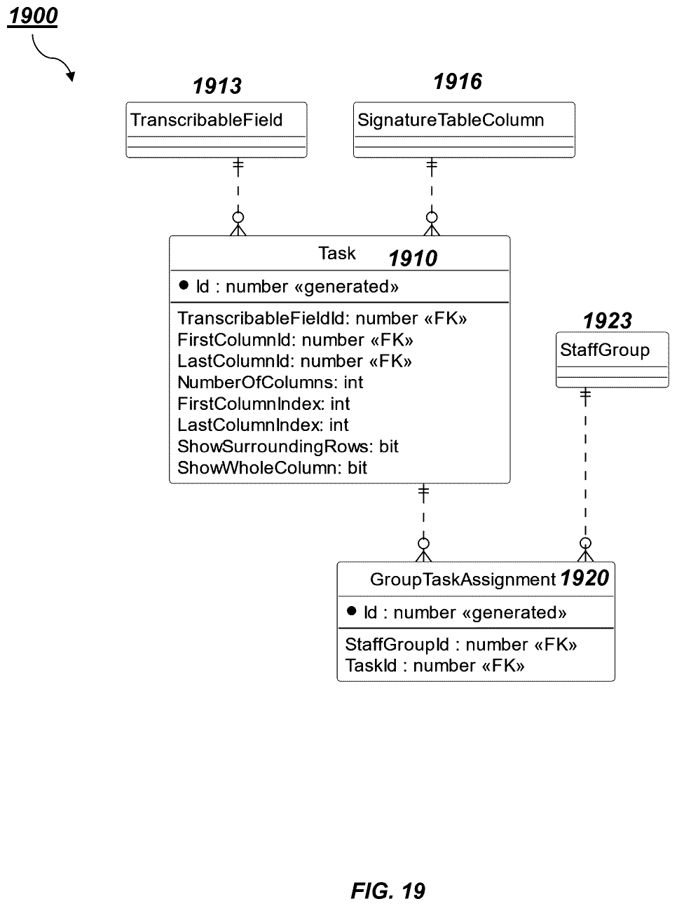

FIG. 19 is a simplified block diagram illustrating example architecture 1900 in accordance with various embodiments. In some aspects, the diagram of FIG. 19 relates to tables associated with staff manager user group assignment operations and group task assignment operations, including transcribable field 1913 and signature table column 1916 with respect to a given task module 1910. Module 1910 can be in communication with group task assignment module 1920 and one or more staff user groups 1923.

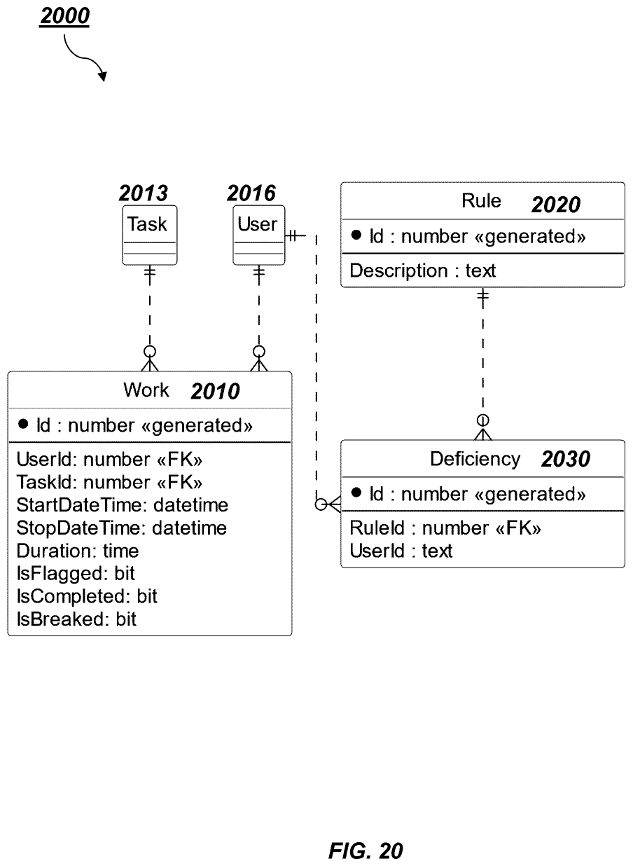

FIG. 20 is a simplified block diagram illustrating example architecture 2000 in accordance with various embodiments. In some aspects, the diagram of FIG. 20 relates to tables associated with transcription operations and rule validation operations, including task 2013 and user 2016 each in communication with work module 2010 and deficiency module 2030. Module 2030 can be in communication with deficiency rule module 2020 to perform document deficiency analytical operations.

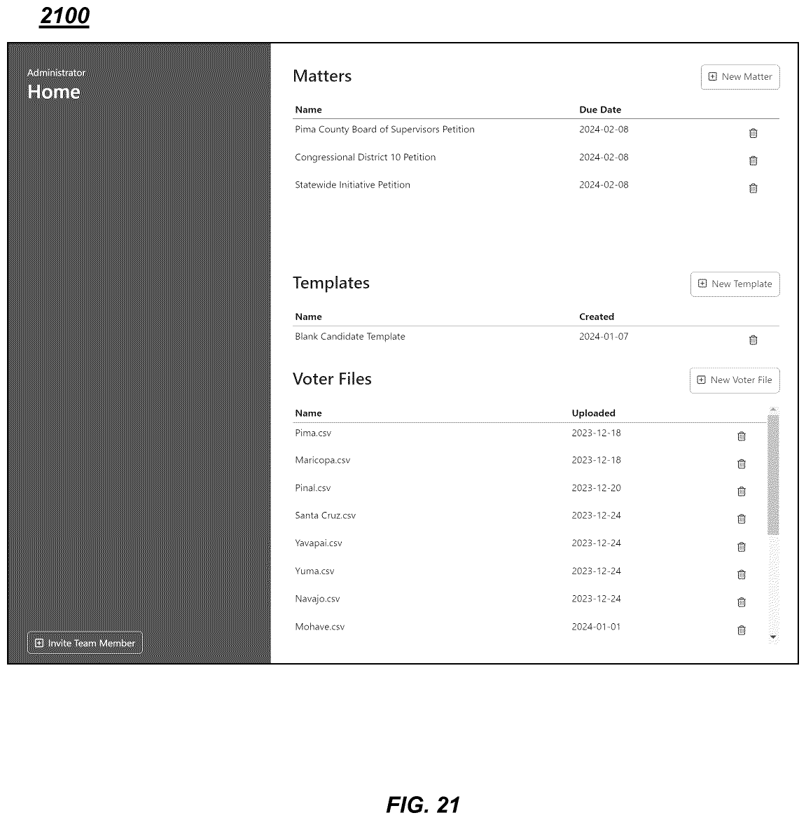

Turning to the example interface 2100 of FIG. 21, the user can view status of current batch analysis operations, upload and/or access one or more petition analysis templates, and access and/or upload voter registration file databases associated with a jurisdiction.

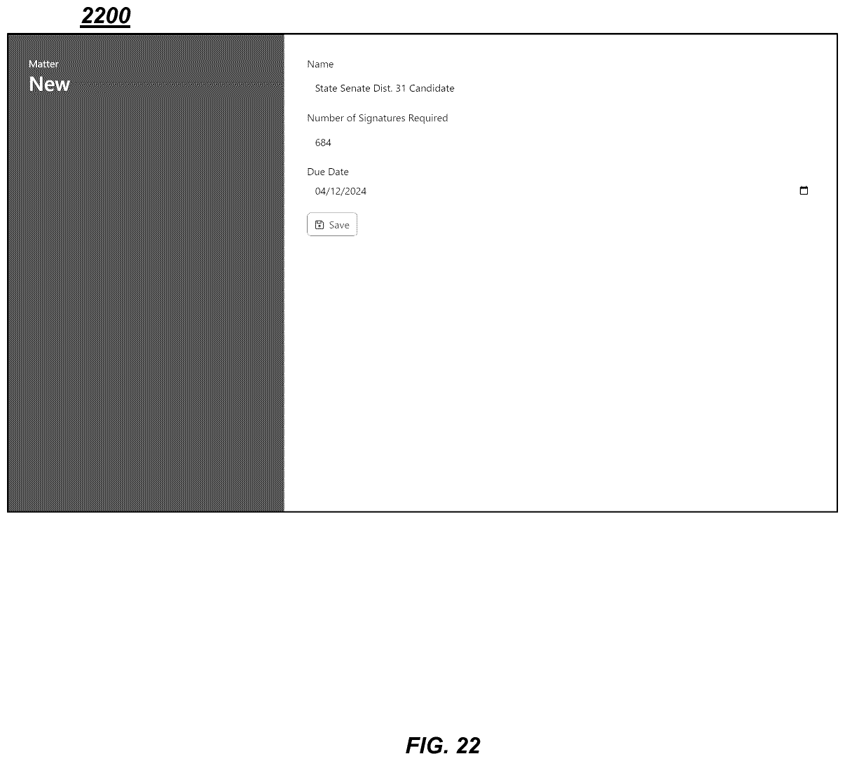

Turning to the example interface 2200 of FIG. 22, the user can initiate a petition analysis operation, including entering a jurisdiction signature rule threshold data and enter a petition challenge deadline data.

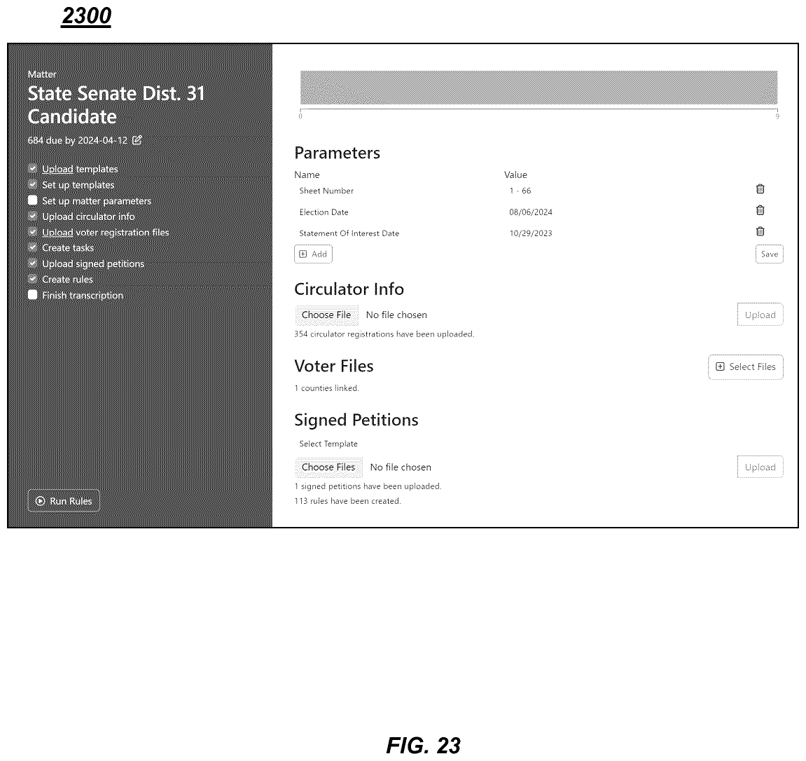

Turning to the example interface 2300 of FIG. 23, the user interface presents information related to a petition challenge, including status of suboperations (e.g., upload template operation, set up template operation, set up matter parameters operation, upload circulator information operation, upload voter registration information, create task information, upload signed petition information, create rule information, finish transcription information, etc.). In the depicted example, parameters, circulator information, voter files, and signed petition data related to the petition challenge can be verified, uploaded, viewed, revised, and/or entered.

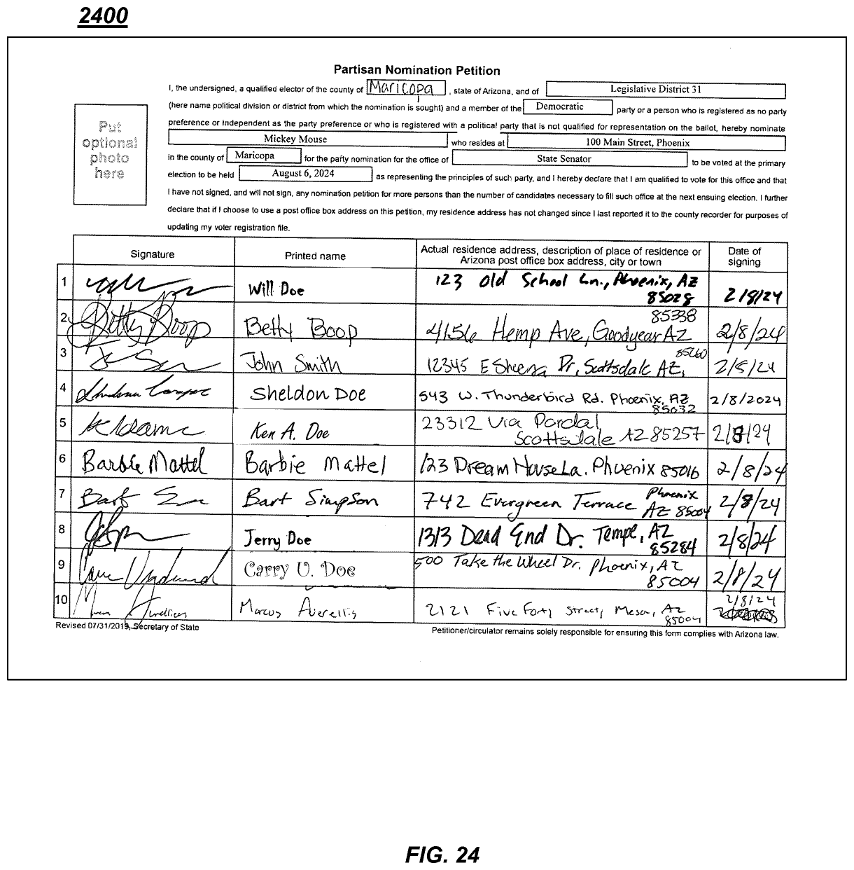

Turning to the interface 2400 of FIG. 24, the user interface presents information related to a petition challenge. In the depicted scanned image data, one or more petition validation fields associated with a voter of a petition can be verified utilizing one or more modules of the system. In some aspects, optical character recognition can be performed upon the scanned images of a petition, voter information can be extracted from system identified areas of interest of the scanned images, and extracted voter information can be compared to voter data of an associated voter registration database, to determine if the information matches the voter record in the voter registration database. FIG. 24 shows an exemplary scanned petition with multiple voter information and signatures that can be potentially challenged by referencing information from the voter registration database.

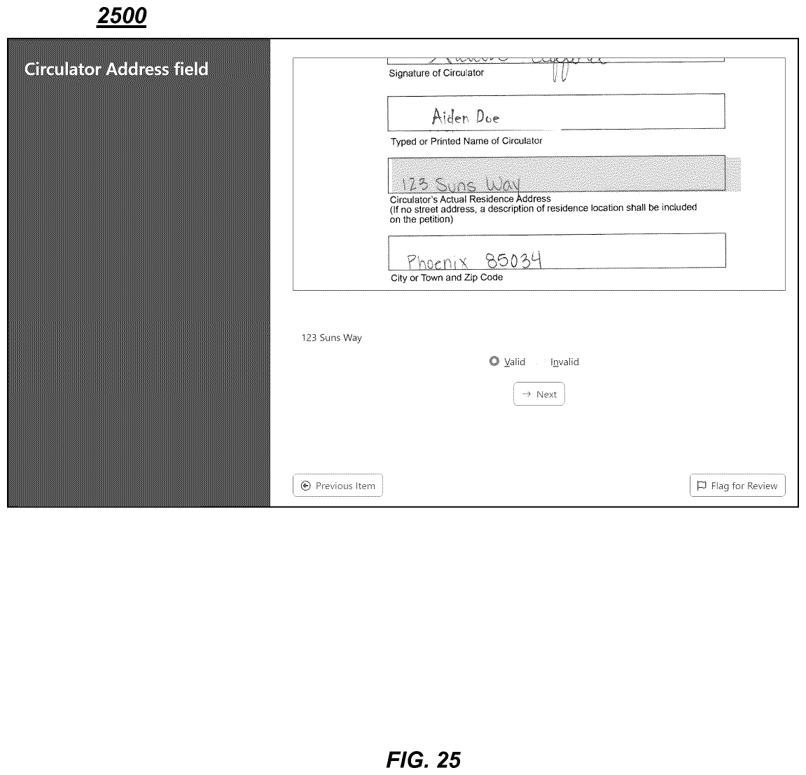

Turning to the interface 2500 of FIG. 25, the user interface presents information related to a petition challenge. In the depicted scanned image data, an image can be generated by the system that includes a close-up of an identified field of interest and a system-annotated overlay presenting a data verification query window to the user or the system. In the presented window, the user or the system can determine whether extracted character information or other data of the field of interest is a match with the petition requirement information.

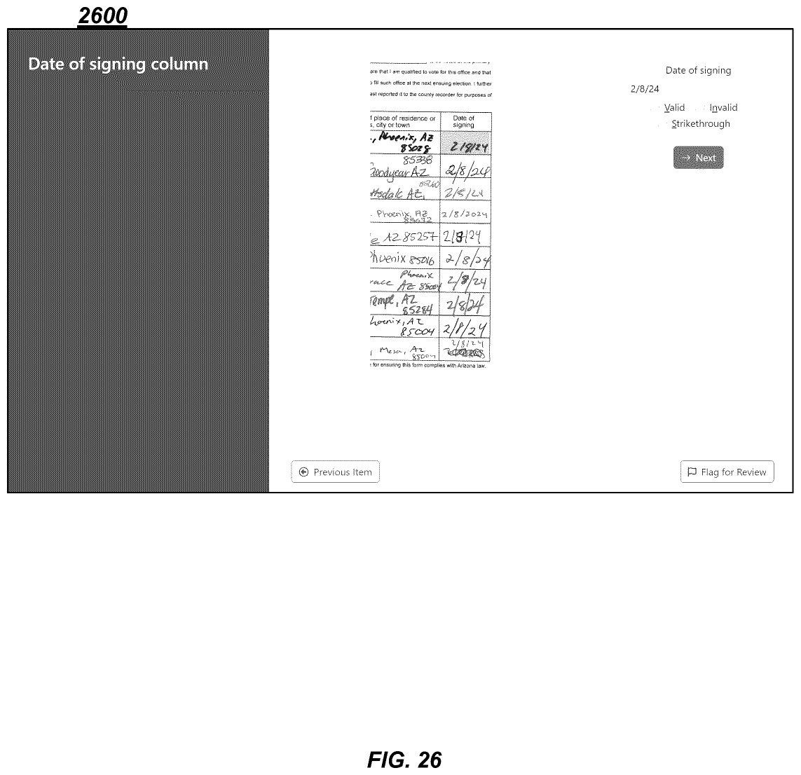

Turning to the interface 2600 of FIG. 26, the user interface presents information related to a petition challenge. In the depicted scanned image data, an image can be generated by the system that includes a close-up of an identified field of interest and a system-annotated overlay presenting a data verification query window to the user or the system. In the presented window, the user or the system can determine whether extracted character information or other data of the field of interest is a match with the petition requirement information.

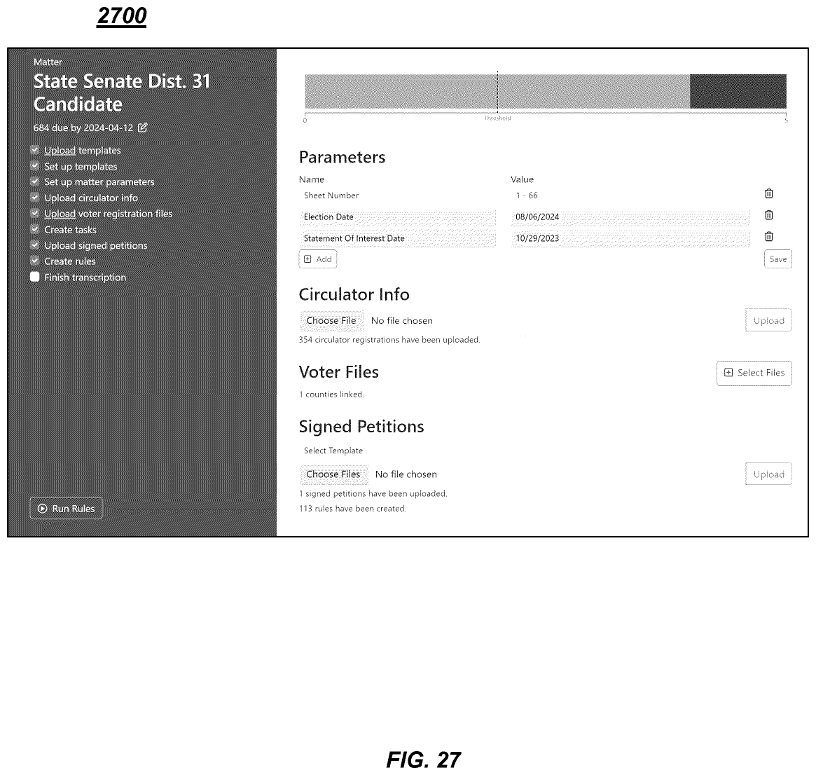

Turning to the interface 2700 of FIG. 27, the user interface presents dashboard information similar to the example dashboard shown in FIG. 23, related to a petition challenge. In the depicted interface, a current score is shown related to total deficiencies identified in the scanned image data of a petition (e.g., 7) which is analyzed and here determined by the system to be above a threshold requirement related to the petition challenge.

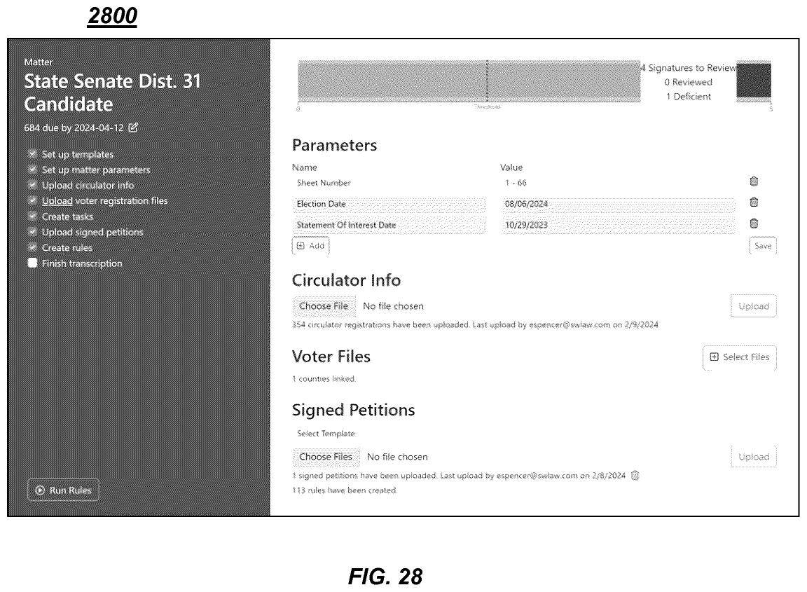

Turning to the interface 2800 of FIG. 28, the user interface presents dashboard information similar to the example dashboard shown in FIGS. 23 and 27. In the depicted example, the dashboard summarizes remaining documents related to the voter related action (e.g., a petition) to be reviewed, amount already reviewed, and total deficiency score, each in relation to a threshold requirement of the voter related action.

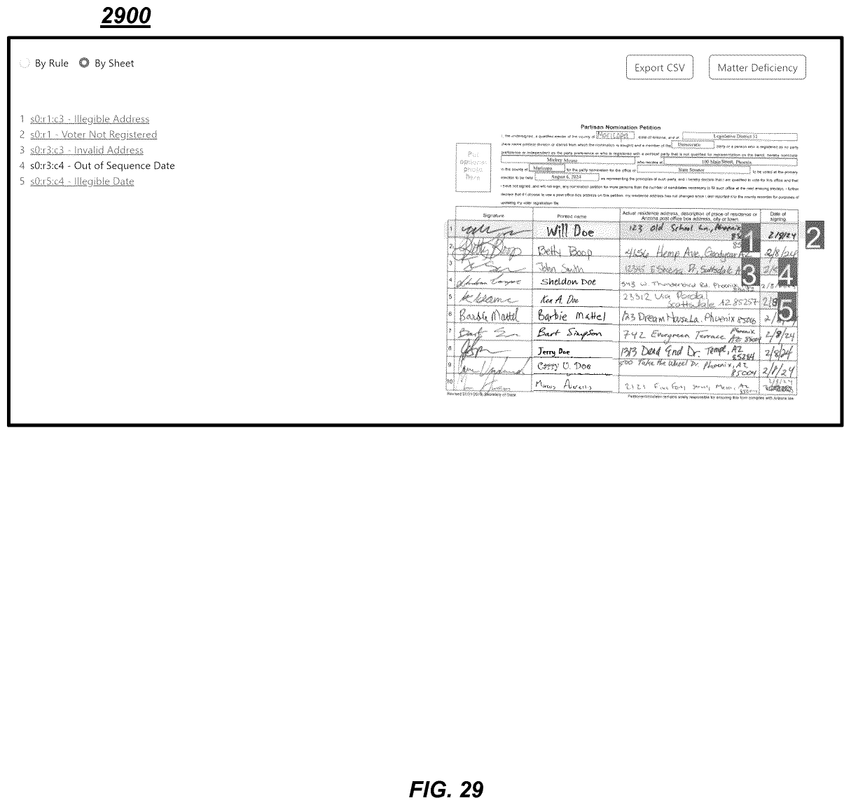

Turning to the interface 2900 of FIG. 29, the user interface presents information related to a petition challenge. In the depicted scanned image data, an image can be generated by the system that includes a system-annotated overlay with autogenerated challenge annotations added to the scanned image based on system identified bases to challenge the voter related action. In some aspects, a legend summarizing each autogenerated challenge annotations can be presented side-by-side with the system-annotated overlay.

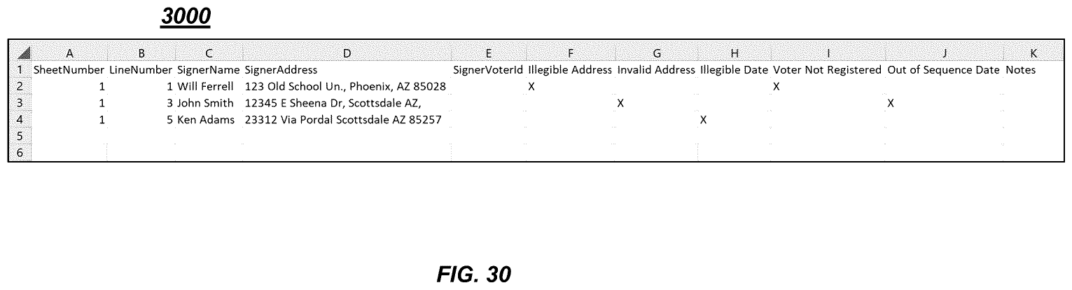

Turning to the example of FIG. 30, an example system generated table 3000 is shown that includes data of each basis of challenging the document associated with the voter related action. In the depicted example, in response to identifying and verifying each basis of challenging the document of the voter related action, table 3000 is automatically generated in a predetermined filing format according to one or more rules associated the jurisdiction associated with the voter related action.

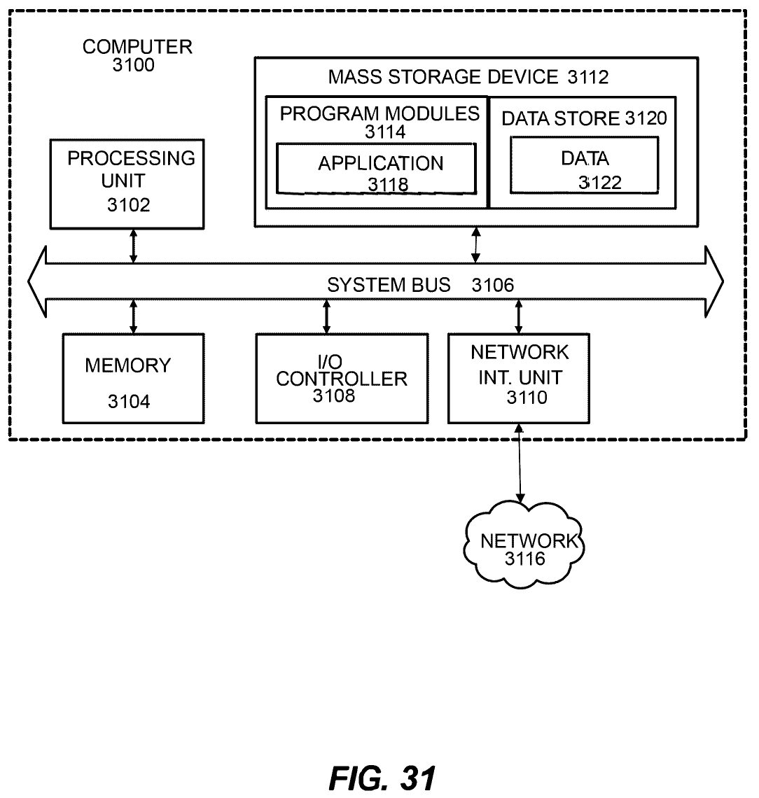

FIG. 31 is a computer architecture diagram showing a general computing system capable of implementing aspects of the present disclosure in accordance with one or more embodiments described herein. In any of these example implementations, computer 3100 of the aforementioned may be configured to perform one or more functions associated with embodiments of this disclosure. For example, the computer 3100 may be configured to perform operations in accordance with those examples shown in FIGS. 1A to 30. It should be appreciated that the computer 3100 may be implemented within a single computing device or a computing system formed with multiple connected computing devices. The computer 3100 may be configured to perform various distributed computing tasks, in which processing and/or storage resources may be distributed among the multiple devices. The data acquisition and display computer 3150 and/or operator console 3110 of the system shown in FIG. 31 may include one or more systems and components of the computer 3100.

As shown, the computer 3100 includes a processing unit 3102 (“CPU”), a system memory 3104, and a system bus 3106 that couples the memory 3104 to the CPU 3102. The computer 3100 further includes a mass storage device 3112 for storing program modules 3114. The program modules 3114 may be operable to analyze data from any herein disclosed components and/or control any related operations. The program modules 3114 may include an application 3118 for performing data acquisition and/or processing functions as described herein, for example to acquire and/or process any of the herein discussed data feeds. The computer 3100 can include a data store 3120 for storing data that may include data 3122 of data feeds from system components.

The mass storage device 3112 is connected to the CPU 3102 through a mass storage controller (not shown) connected to the bus 3106. The mass storage device 3112 and its associated computer-storage media provide non-volatile storage for the computer 3100. Although the description of computer-storage media contained herein refers to a mass storage device, such as a hard disk or CD-ROM drive, it should be appreciated by those skilled in the art that computer-storage media can be any available computer storage media that can be accessed by the computer 3100.

By way of example and not limitation, computer storage media (also referred to herein as “computer-readable storage medium” or “computer-readable storage media”) may include volatile and non-volatile, removable and non-removable media implemented in any method or technology for storage of information such as computer-storage instructions, data structures, program modules, or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 3100. “Computer storage media”, “computer-readable storage medium” or “computer-readable storage media” as described herein do not include transitory signals.

According to various embodiments, the computer 3100 may operate in a networked environment using connections to other local or remote computers through a network 3116 via a network interface unit 3110 connected to the bus 3106. The network interface unit 3110 may facilitate connection of the computing device inputs and outputs to one or more suitable networks and/or connections such as a local area network (LAN), a wide area network (WAN), the Internet, a cellular network, a radio frequency (RF) network, a Bluetooth-enabled network, a Wi-Fi enabled network, a satellite-based network, or other wired and/or wireless networks for communication with external devices and/or systems.

The computer 3100 may also include an input/output controller 3108 for receiving and processing input from any of a number of input devices. Input devices may include one or more of keyboards, mice, stylus, touchscreens, microphones, audio capturing devices, and image/video capturing devices. An end user may utilize the input devices to interact with a user interface, for example a graphical user interface, for managing various functions performed by the computer 3100. The bus 3106 may enable the processing unit 3102 to read code and/or data to/from the mass storage device 3112 or other computer-storage media.

The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer storage media may also represent secondary storage, whether implemented as hard drives or otherwise. Hard drive implementations may be characterized as solid state or may include rotating media storing magnetically-encoded information. The program modules 3114, which include the data feed application 3118, may include instructions that, when loaded into the processing unit 3102 and executed, cause the computer 3100 to provide functions associated with one or more embodiments illustrated in the figures of this disclosure. The program modules 3114 may also provide various tools or techniques by which the computer 3100 may participate within the overall systems or operating environments using the components, flows, and data structures discussed throughout this description.

In general, the program modules 3114 may, when loaded into the processing unit 3102 and executed, transform the processing unit 3102 and the overall computer 3100 from a general-purpose computing system into a special-purpose computing system. The processing unit 3102 may be constructed from any number of transistors or other discrete circuit elements, which may individually or collectively assume any number of states. More specifically, the processing unit 3102 may operate as a finite-state machine, in response to executable instructions contained within the program modules 3114. These computer-executable instructions may transform the processing unit 3102 by specifying how the processing unit 3102 transitions between states, thereby transforming the transistors or other discrete hardware elements constituting the processing unit 3102.

Encoding the program modules 3114 may also transform the physical structure of the computer-storage media. The specific transformation of physical structure may depend on various factors, in different implementations of this description. Examples of such factors may include but are not limited to the technology used to implement the computer-storage media, whether the computer storage media are characterized as primary or secondary storage, and the like. For example, if the computer storage media are implemented as semiconductor-based memory, the program modules 3114 may transform the physical state of the semiconductor memory, when the software is encoded therein. For example, the program modules 3114 may transform the state of transistors, capacitors, or other discrete circuit elements constituting the semiconductor memory.

As another example, the computer storage media may be implemented using magnetic or optical technology. In such implementations, the program modules 3114 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

According to certain embodiments, the above-described data feeds may be stored in databases such as database servers that store master data as well as logging and trace information. The databases may also provide an API and/or API access (e.g., for open source) to the web server for data interchange based on JSON specifications. According to certain embodiments, the database servers may be optimally designed for storing large amounts of data, responding quickly to incoming requests, having a high availability and historizing master data.

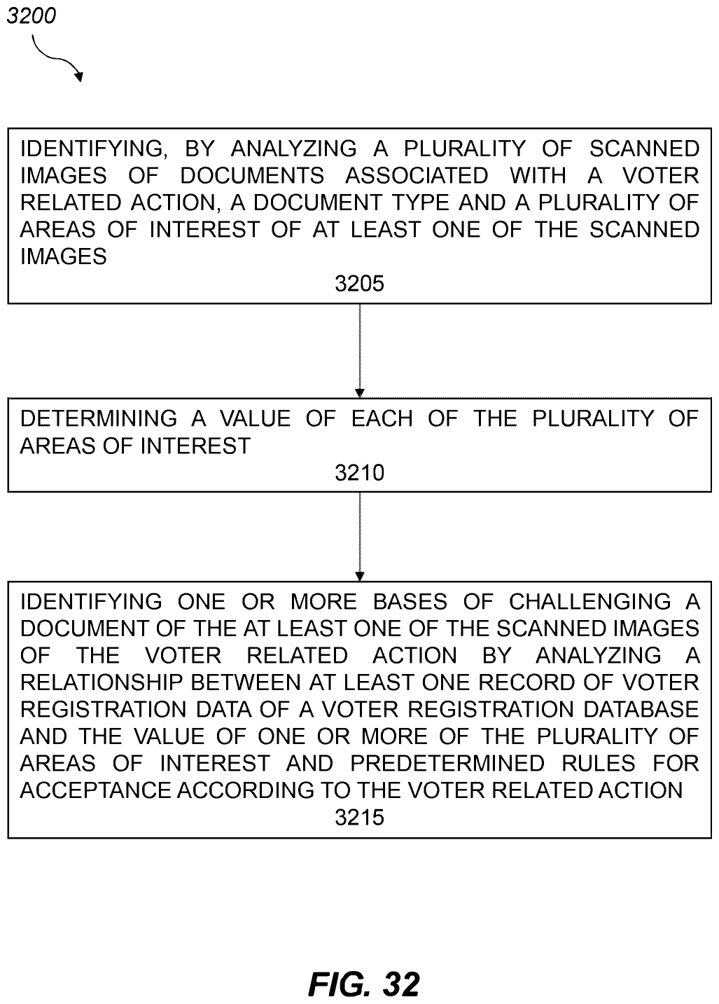

FIG. 32 is a method 3200 for processing scanned images of a document related to voter related actions. Step 3205 of method 3200 can include identifying, by analyzing a plurality of scanned images of documents associated with a voter related action, a document type and a plurality of areas of interest of at least one of the scanned images. Step 3210 of method 3200 can include determining a value of each of the plurality of areas of interest. Step 3215 of method 3200 can include identifying one or more bases of challenging a document of the at least one of the scanned images of the voter related action by analyzing a relationship between at least one record of voter registration data of a voter registration database and the value of one or more of the plurality of areas of interest and predetermined rules for acceptance according to the voter related action.

It is also to be understood that the mention of one or more steps of method 3200 does not preclude the presence of additional method steps or intervening method steps between those steps expressly identified. Steps of method 3200 may be performed in a different order than those described herein without departing from the scope of the disclosed technology.

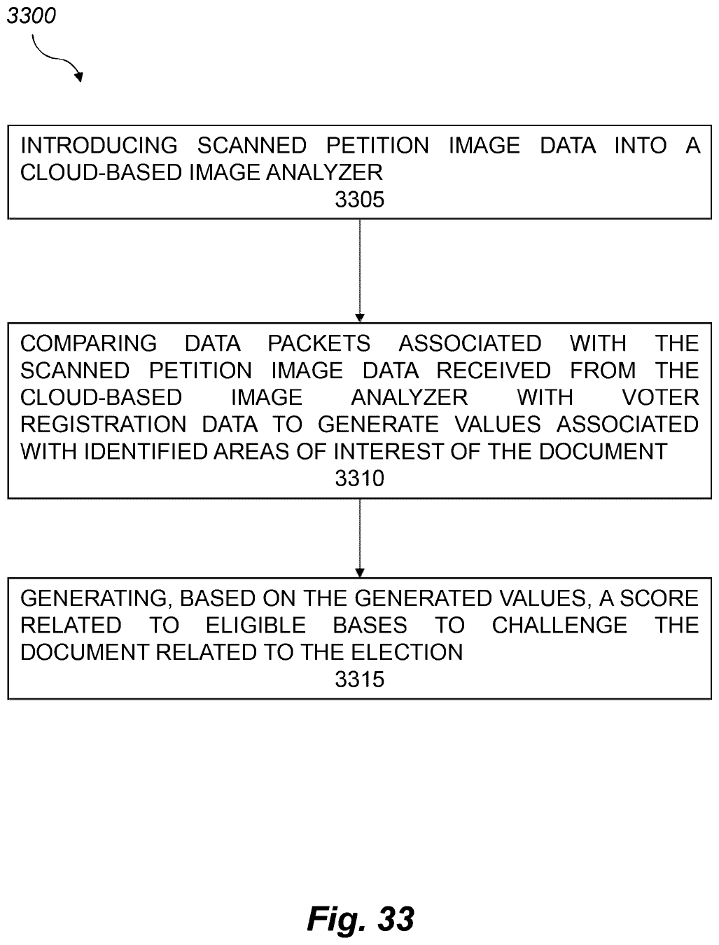

FIG. 33 is a method 3300 for processing scanned images of a document related to voter related actions. Step 3305 of method 3300 can include introducing scanned petition image data into a cloud-based image analyzer. Step 3310 of method 3200 can include comparing data packets associated with the scanned petition image data received from the cloud-based image analyzer with voter registration data to generate values associated with identified areas of interest of the document. Step 3315 of method 3200 can include generating, based on the generated values, a score related to eligible bases to challenge the document related to the voter related action.

In the description herein, numerous specific details are set forth. However, it is to be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the present disclosure so described may include a particular feature, structure, or characteristic, but not every embodiment necessarily includes the particular feature, structure, or characteristic. Further, repeated use of the phrase “in one embodiment” does not necessarily refer to the same embodiment, although it may.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor (e.g., a processor chip, single/multi-processor architectures, sequential (Von Neumann)/parallel architectures, and specialized circuits, etc.), or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of the present disclosure may provide for a computer program product, including a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Various aspects described herein may be implemented using standard programming and/or engineering techniques to produce software, firmware, hardware, and/or any combination thereof to control a computing device to implement the disclosed subject matter. A computer-readable medium may include, for example: a magnetic storage device such as a hard disk, a floppy disk or a magnetic strip; an optical storage device such as a compact disk (CD) or digital versatile disk (DVD); a smart card; and a flash memory device such as a card, stick or key drive, or embedded component. Additionally, it should be appreciated that a carrier wave may be employed to carry computer-readable electronic data including those used in transmitting and receiving electronic data such as streaming video or in accessing a computer network such as the Internet or a local area network (LAN). Of course, a person of ordinary skill in the art will recognize many modifications may be made to this configuration without departing from the scope or spirit of the claimed subject matter.

It is also to be understood that the mention of one or more steps of method 3200 does not preclude the presence of additional method steps or intervening method steps between those steps expressly identified. Steps of method 3300 may be performed in a different order than those described herein without departing from the scope of the disclosed technology.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the disclosed technology. Similarly, it is also to be understood that the mention of one or more components in a device or system does not preclude the presence of additional components or intervening components between those components expressly identified.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software, and hardware. Furthermore, the system may take the form of a computer program product on a computer-readable storage medium having computer-readable program code means embodied in the storage medium.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations, including but not limited to operations of cognitive services 117, may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices. The AI or ML may store data in a decision tree in a novel way.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies.

The system contemplates uses in association with web services, utility computing, pervasive and individualized computing, security and identity solutions, autonomic computing, cloud computing, commodity computing, mobility and wireless solutions, open source, biometrics, grid computing, and/or mesh computing.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB such as with respect to blob storage 120. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

The particular blockchain implementation described herein provides improvements over conventional technology by using a decentralized database and improved processing environments. In particular, the blockchain implementation improves computer performance by, for example, leveraging decentralized resources (e.g., lower latency). The distributed computational resources improves computer performance by, for example, reducing processing times. Furthermore, the distributed computational resources improves computer performance by improving security using, for example, cryptographic protocols.

While certain embodiments of the present disclosure have been described in connection with what is presently considered to be the most practical and various embodiments, it is to be understood that the present disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The specific configurations, choice of materials and the size and shape of various elements can be varied according to particular design specifications or constraints requiring a system or method constructed according to the principles of the disclosed technology. Such changes are intended to be embraced within the scope of the disclosed technology. The presently disclosed embodiments, therefore, are considered in all respects to be illustrative and not restrictive. It will therefore be apparent from the foregoing that while particular forms of the disclosure have been illustrated and described, various modifications can be made without departing from the spirit and scope of the disclosure and all changes that come within the meaning and range of equivalents thereof are intended to be embraced therein.

What is claimed is:

1. A computer-implemented system, comprising:
one or more memories storing instructions; and
one or more processors configured to execute the instructions to perform operations configured to:
identify, by analyzing a plurality of scanned images of documents associated with a voter related action, a document type and a plurality of areas of interest of at least one of the scanned images;
determine a value of each of the plurality of areas of interest; and
identify one or more bases of challenging a document of the at least one of the scanned images of the voter related action by analyzing a relationship between at least one record of voter registration data of a voter registration database and the value of one or more of the plurality of areas of interest and predetermined rules for acceptance according to the voter related action.

2. The system of claim 1, wherein the document comprises a petition.

3. The system of claim 1, wherein the determine the value of each of the plurality of areas of interest comprises determine, using a cloud-based computer vision machine learning system that applies optical character recognition to the each of the plurality of areas of interest to identify characters of the value.

4. The system of claim 1, further configured to:
verify the one or more bases of challenging the document in a display dashboard; and
generate, based on the verifying the one or more bases, a petition challenge score comprising available grounds to challenge the document.

5. The system of claim 1, further configured to:
generate an annotated image by automatically annotating at least one of the areas of interest with overlayed analytics related to at least one identified basis of challenging the document; and
present the annotated image in a user interface.

6. The system of claim 1, further configured to:
generate an annotated image by automatically annotating at least one of the areas of interest with overlayed analytics related to at least one identified basis of challenging the document; and
automatically modify the annotated image in a predetermined filing format with one or more litigation tags.

7. The system of claim 1, further comprising:
a data pipeline in communication with a machine learning model comprising cognitive services trained on historical voter and/or petition data, a database comprising transcription data, and a cloud based storage,
the instructions to perform operations further configured to:
execute, using at least the data pipeline, a scanned image data query and a signature data query of the plurality of scanned images; and
load, using at least the data pipeline and a signature data grouping query, output of the executed scanned image data query and the signature data query into one or more tables prior to the operation to identify the one or more bases of challenging the document.

8. The system of claim 1, further configured to automatically generate a table comprising data of each basis of challenging the document, the table being formed in a predetermined filing format according to one or more litigation rules.

9. A method for processing scanned images of a document related to voter related actions, comprising:
identifying, by analyzing a plurality of scanned images of documents associated with a voter related action, a document type and a plurality of areas of interest of at least one of the scanned images;
determining a value of each of the plurality of areas of interest; and
identifying one or more bases of challenging a document of the at least one of the scanned images of the voter related action by analyzing a relationship between at least one record of voter registration data of a voter registration database and the value of one or more of the plurality of areas of interest and predetermined rules for acceptance according to the voter related action.

10. The method of claim 9, wherein the document comprises a petition.

11. The method of claim 9, wherein the determining the value of each of the plurality of areas of interest comprises determining, using a cloud-based computer vision machine learning system that applies optical character recognition to the each of the plurality of areas of interest to identify characters of the value.

12. The method of claim 11, further comprising training the cloud-based computer vision machine learning system by receiving one or more training plurality of training images of documents associated with the voter related action; receiving a plurality of data on a level of the areas of interest, values, and rules for acceptance according to the voter related action.

13. The method of claim 9, further comprising:
verifying the one or more bases of challenging the document in a display dashboard; and
generating, based on the verifying the one or more bases, a petition challenge score comprising available grounds to challenge the document.

14. The method of claim 9, further comprising:
generating an annotated image by automatically annotating at least one of the areas of interest with overlayed analytics related to at least one identified basis of challenging the document; and
presenting the annotated image in a user interface.

15. The method of claim 9, further comprising:
generating an annotated image by automatically annotating at least one of the areas of interest with overlayed analytics related to at least one identified basis of challenging the document; and
automatically modifying the annotated image in a predetermined filing format with one or more litigation tags.

16. The method of claim 9, further comprising automatically generating a table comprising data of each basis of challenging the document, the table being formed in a predetermined filing format according to one or more litigation rules.

17. The method of claim 9, further comprising:
loading, using at least a data pipeline in connection with a cognitive service, a database comprising transcription data, and a cloud based storage, a scanned image data query, and a signature data grouping query, an output of each query into one or more tables prior to or concurrent with determining the value of each of the plurality of areas of interest according to one or more litigation rules.

18. A method for processing scanned images of a document related to a voter related action, comprising:
introducing scanned petition image data into a cloud-based image analyzer;
comparing data packets associated with the scanned petition image data received from the cloud-based image analyzer with voter registration data to generate values associated with identified areas of interest of the document; and
generating, based on the generated values, a score related to eligible bases to challenge the document related to the voter related action.

19. The method of claim 18, wherein the document comprises a petition, the method further comprising:
generating an annotated image by automatically annotating at least one of the identified areas of interest with overlayed analytics related to at least one identified eligible basis of challenging the document; and
presenting the annotated image in a user interface.

20. The method of claim 18, further comprising:
executing, using at least a data pipeline, a scanned image data query and a signature data query of the scanned petition image data; and
loading, using at least the data pipeline and a signature data grouping query, output of the executed scanned image data query and the signature data query into one or more tables.
